(19) United States
(12) Patent Application Publication
(10) Pub. No.: US 2009/0265694 A1
(43) Pub. Date: Oct. 22, 2009

(54) METHOD AND SYSTEM FOR TEST FAILURE ANALYSIS PRIORITIZATION FOR SOFTWARE CODE TESTING IN AUTOMATED TEST EXECUTION

(75) Inventor: Ben Bakowski, Romsey (GB)

Correspondence Address: IBM-ACC-Washington;c/o Myers Dawes Andras & Sherman, LLP, 19900 MacArthur Blvd., 11th Floor, Irvine, CA, 92612, US

(73) Assignee: International Business Machines Corporation, Armonk, NY (US)

(21) Appl. No.: 12/106,207

(22) Filed: Apr. 18, 2008

(51) Int. Cl. G06F 9/44

(52) U.S. Cl. 717/131

(57) ABSTRACT

A method and system for software code testing for an automated test execution environment is provided. Testing involves importing test case information into a tooling environment based on code coverage and targeted testing, the test information including test name and code coverage data including classes and methods exercised by the code; generating a test hierarchy by analyzing the individual test case information; selecting tests including one or more of: all tests for a full regression run, a subset of tests for basic quality assurance or testing a particular area of functionality, and tests that exercise a recently changed class; executing selected tests to generate a pass/fail result for each test and correlating the test results; performing test failure analysis prioritization to prioritize any failures.

### BACKGROUND OF THE INVENTION

1. Field of the Invention

The present invention relates generally to software testing and in particular to automated software code testing.

2. Background Information

The rapidly increasing complexity of software code has enhanced the need for successful test strategies to improve quality. One such strategy is regression testing, in which tests are regularly run against milestone builds of a software product codebase to detect regressions, i.e., breaking of existing functionality. Success in regression testing relies on regressions being found, isolated, and fixed quickly, preventing code instabilities from aggregating and leading to quality degradation.

There is, consequently, a significant drive to improve the efficiency of a regression test, though significant problems remain when testing complex software. Typically, a regression bucket contains thousands of individual test cases, many of which may fail when exposed to multiple defects. It is impractical to analyze all failures as it is simply too resource-intensive. A risk-based approach is commonly employed, in which the tester assesses which test failures to address first. If multiple test failures are potentially caused by the same defect, one test case is analyzed to avoid duplication of effort. Where possible, the simplest tests are selected for analysis. Though defects are flushed out, selecting which test failures to analyze requires a deep understanding of the product and test codebases.

Further, executing thousands of test permutations against all product builds is generally unfeasible due to the sheer hardware and time resources required. Instead, a common practice is to run a subset of suites first to assess general product quality, before proceeding to execute further in-depth tests to probe more deeply. Interpretation of these preliminary results requires the tester to possess significant insight into the product and test code.

Conventional testing tools attempt to improve test efficiency by providing approaches to help identify test cases to run. These approaches, often based on code coverage, broadly fall into three categories. A first approach maximizes code coverage by determining the code coverage provided by each test case, wherein test cases can be executed in an order to maximize overall coverage with as few tests as possible. Regression defects are exposed earlier, but most complex tests provide the highest code coverage and hence are recommended first. Any defects found using this approach may therefore be difficult to analyze.

A second approach involves targeted testing wherein each new product build contains incremental changes to its code base. By analyzing these changes, and correlating test cases that probe these changes, a recommendation of which tests to execute can be made. However, there is no scope for considering analysis of the results themselves A third approach utilizes historical results and makes recommendations using test case track records in yielding defects. However, this approach offers little over conventional regression testing techniques.

### SUMMARY OF THE INVENTION

The invention provides a method and system for Test Failure Analysis Prioritization (TFAP) in software code testing for an automated test execution environment. One embodiment includes performing analysis on executed tests' results. Test failures are caused by defects in the products. The invention provides a mechanism to identify which of these failures should be investigated first, based on (i) their relative complexity compared to other tests and (ii) the likelihood that “fixing” this test will automatically fix other failing tests as well. One implementation involves importing test case information into a tooling environment based on code coverage and targeted testing, the test information including test name and code coverage data including classes and methods exercised by the code; generating a test hierarchy by analyzing the individual test case information; selecting tests including one or more of: all tests for a full regression run, a subset of tests for basic quality assurance or testing a particular area of functionality, and tests that exercise a recently changed class; executing selected tests to generate a pass/fail result for each test and correlating the test results; and performing test failure analysis prioritization to prioritize any failures.

Other aspects and advantages of the present invention will become apparent from the following detailed description, which, when taken in conjunction with the drawings, illustrate by way of example the principles of the invention.

### BRIEF DESCRIPTION OF THE DRAWINGS

For a fuller understanding of the nature and advantages of the invention, as well as a preferred mode of use, reference should be made to the following detailed description read in conjunction with the accompanying drawings, in which:

FIG. 1 shows an example import process involving importing test cases into a tooling environment 14, according to the invention.

FIG. 2 shows an example test case execution process, according to the invention.

FIG. 3 shows an example regression scenario, according to the invention.

FIG. 4 shows an example test case hierarchy, according to the invention.

FIG. 5 shows an example test run scenario, according to the invention.

FIG. 6 shows an example alternative hierarchy-based perspective, according to the invention.

FIG. 7 shows example Test Failure Analysis Prioritization (TFAP) information, according to the invention.

FIG. 8 shows another example test run, according to the invention.

FIG. 9 shows another test hierarchy for several test cases in the regression bucket.

FIG. 10 shows a functional block diagram of a process for determining software test case complexity, according to an embodiment of the invention.

FIG. 11 shows a functional block diagram of a process for determining test case hierarchy based on complexity, according to an embodiment of the invention.

### DESCRIPTION OF THE PREFERRED EMBODIMENTS

The invention provides a method and system for software code testing for an automated test execution environment. The testing is based on code coverage, wherein test cases are recognized not to be mutually exclusive units, but instead are correctly treated as a hierarchy of functional coverage. By understanding this hierarchy, test failures can be used to infer properties about potential defects. This reduces/eliminates the need for in-depth knowledge of the software product or test code when selecting test failures to analyze, allowing the tester to focus on a much smaller subset of failures. The invention further provides targeted testing for analyzing and interpreting test failures. Risk-based approaches are provided for improving the efficiency of testing, without the need for testers to rely on in-depth knowledge of the product or test code. The tooling is based on existing technologies of code coverage and targeted testing, and can be readily integrated into an existing automated test execution environment.

One embodiment involves importing test case information into a tooling environment based on code coverage and targeted testing, the test information including test name and code coverage data including classes and methods exercised by the code; generating a test hierarchy by analyzing the individual test case information; selecting tests including one or more of: all tests for a full regression run, a subset of tests for basic quality assurance or testing a particular area of functionality, and tests that exercise a recently changed class; executing selected tests to generate a pass/fail result for each test and correlating the test results; performing test failure analysis prioritization to prioritize any failures. Referring to the drawings, an implementation is now described.

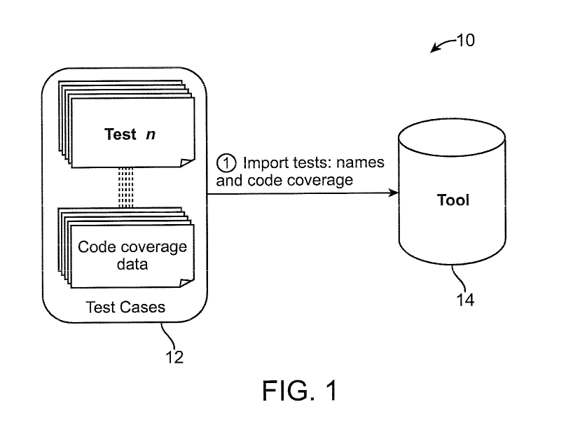

FIG. 1 shows an example import process 10 involving importing test cases 12, including test code and code coverage data, into a tooling environment 14. The required information includes a test name and code coverage data (e.g., the classes and methods exercised by the test code, which can be obtained from standard code coverage tools). Importing test cases and code coverage data into a tooling environment needs to be performed once, although new tests can be added as deltas to the existing data stored in the tool. The tool 14 does not “contain” the tests themselves; rather it simply contains a repository of test names and the functional coverage they exercise. The tooling automatically constructs the test hierarchy by analyzing the individual test case information. Each test case exists in a hierarchy. More complicated test cases sit at the top, while simple test cases sit at the bottom. Common product functionality exercised by these test cases provides the links in this hierarchy.

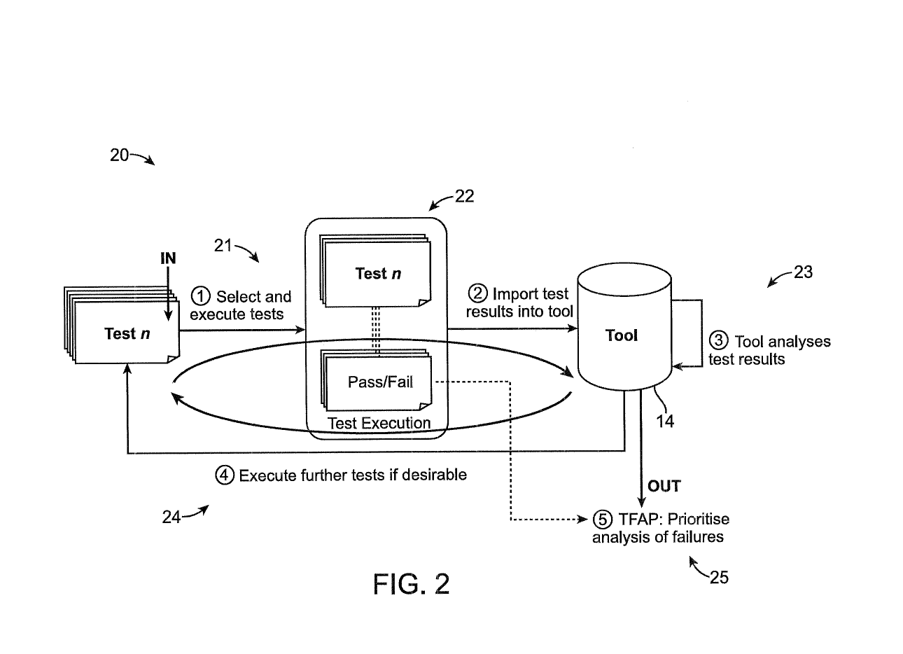

FIG. 2 shows an example text execution process 20. Fully automatic execution of tests involves: (1) in step 21 tests are selected, (2) in step 22 the selected tests are executed and the results are directed to the tool 14, (3) in step 23 the tool 14 analyzes the results, (4) in step 24 if not all tests are run, further tests can be executed, and (5) in step 25 prioritization of test failure analysis is performed. Cyclic arrows show iterative procedures. The result is a list of failures, prioritized for analysis. Specifically, once the hierarchy is built up, the tester is ready to run the tests. The tester selects tests to “seed” the tool: ALL tests for a full regression run; SUBSET of tests for basic quality assurance (e.g., build verification test), or testing a particular area of functionality; AUTOMATIC test selection (composition with existing targeted testing technologies, e.g., selecting tests that exercise a recently changed class in the product). The tests are executed and the pass/fail result for each test is routed to the tooling database. The tooling 14 correlates these results with its database of tests and hierarchy, and carries out Test Failure Analysis Prioritization (TFAP) to prioritize any failures.

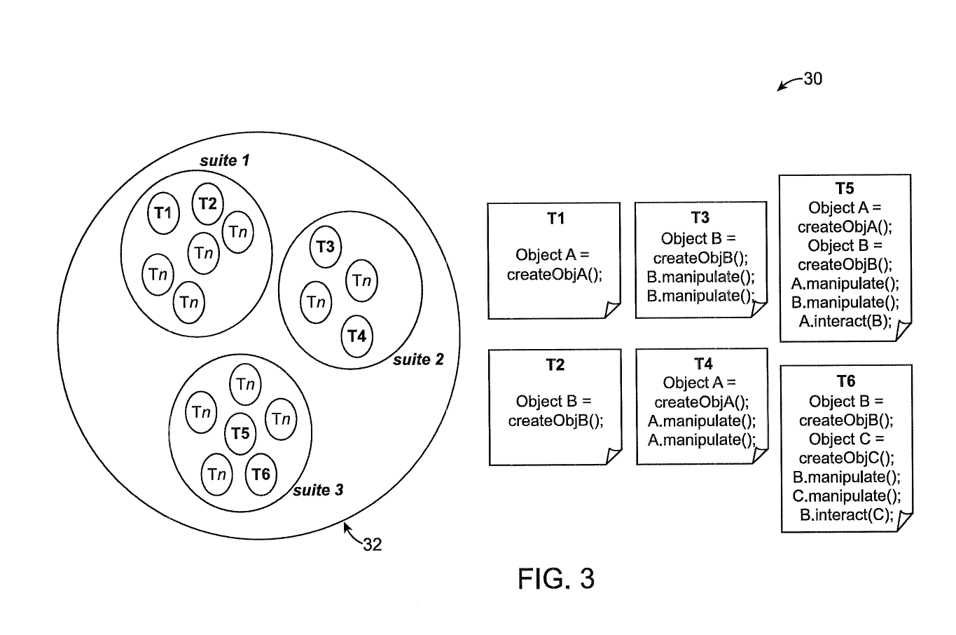

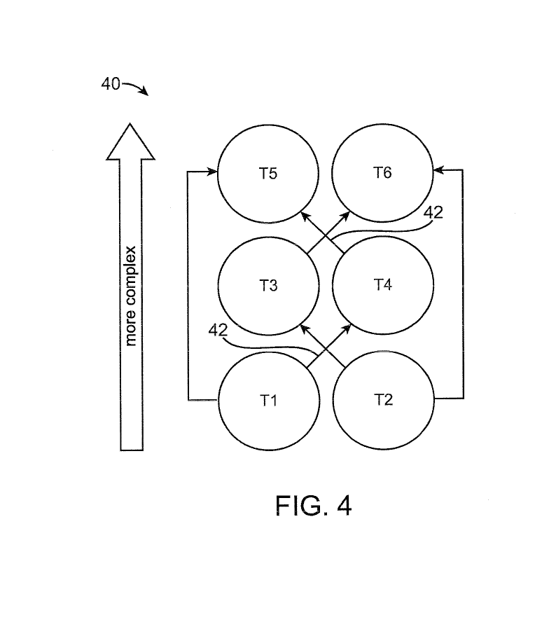

FIG. 3 shows a regression scenario 30, wherein a regression bucket 32 contains three test suites (suite1-suite3) for a product, together with details of test cases (T1-T6) of varying complexity. These test cases exist in a hierarchy 40 shown in FIG. 4. Functional coverage is provided by the tests T1-T6, demonstrating a hierarchy of functional dependence. Bold arrows 42 show an example dependence through a createObjA ( ) method.

### Test Failure Analysis Prioritization (TFAP) Process

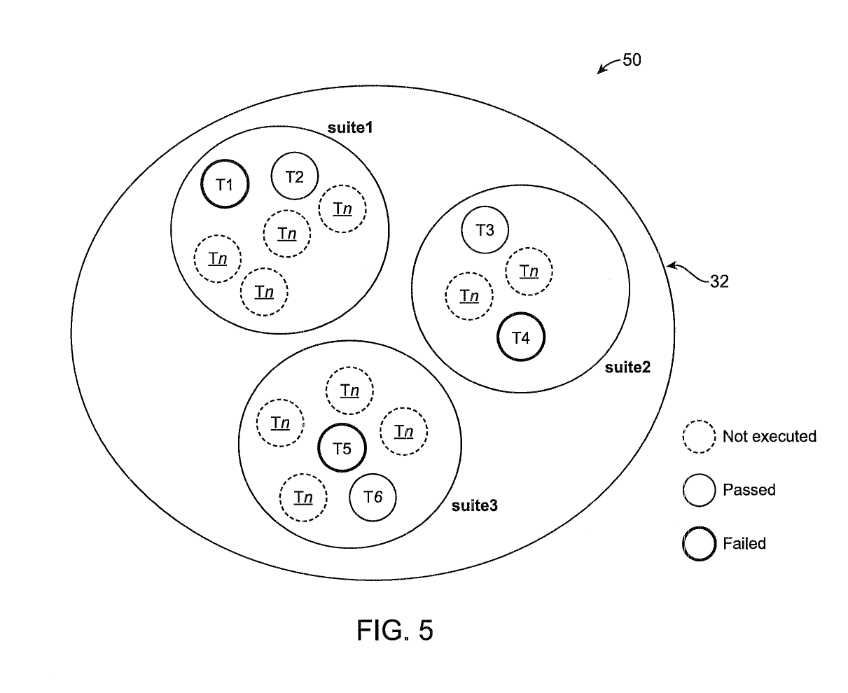

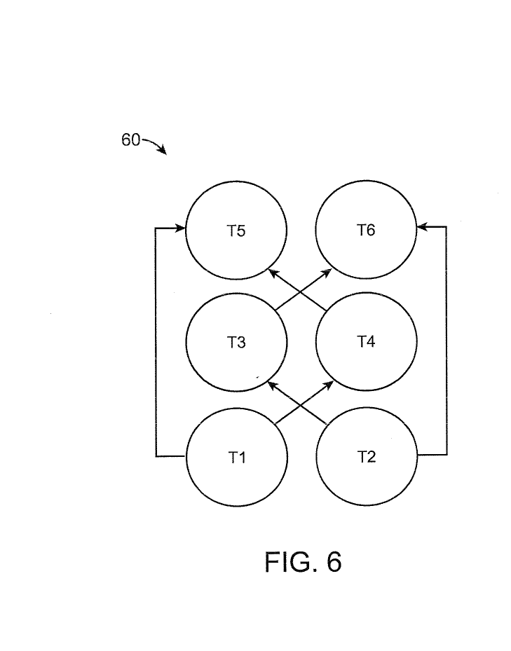

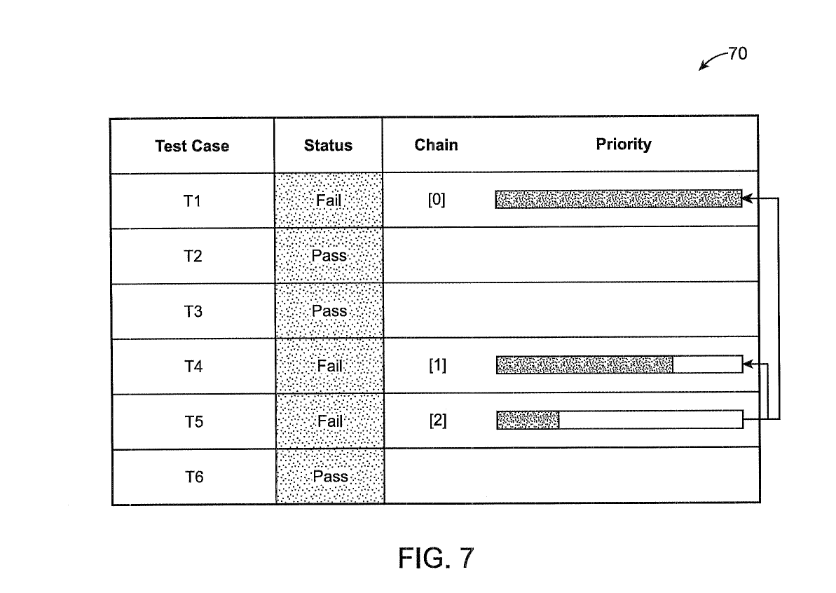

Referring to the example test run scenario 50 in FIG. 5, the regression bucket 32 is shown wherein a tester simply sees these three test failures for T1, T4, T5. The TFAP process prioritizes analysis of these failures for the tester, as follows. Referring to the example TFAP process 60 in FIG. 6, an alternative hierarchy-based perspective of the tooling 14 is utilized. The perspective includes: passes, fails and non-executed tests. The understanding of test interdependence by the tooling 14 allows extraction of important relationships between failures, as presented by the example graphical user interface 70 illustrated in FIG. 7, showing TFAP data, and recommending priorities to a tester for analyzing test failures. The tooling 14 calculates and relays key information on each failing test, including:
1. The tooling determines the number of failing tests that are lower in position in each failing test hierarchy. If no pre-requisite tests fail, a “0” is returned, indicating this is the first instance of a failure in the hierarchy.
2. The tooling generates an analysis priority rating Aₚᵣᵢ, based on: (i) the number of failing tests lower in the hierarchy, Nₗ, (ii) the number of failing tests higher in the hierarchy, Nₕ, and (iii) the complexity of the test case, C (from a code coverage measurement of the number of classes and methods exercised). An example expression is Aₚᵣᵢ=Nₕ/C(Nₗ+1), which favors simple tests earlier in the hierarchy.
3. A display of failing tests in the same hierarchy is shown (e.g., through the graphical link in FIG. 7, or via a simple list).

These result in a priority recommendation from the tooling 14. The tester is only aware there are three failing tests, T1, T4 and T5 (FIG. 5). However, the tooling 14 has determined that analysis of T1 first provides the most value, as it calculates that the test case T1 is a common root for two other test failures, T4, T5, and T1 is the most simple to debug (as it is lowest in the hierarchy). There may be potentially three separate defects causing the test failures, but with no further information, the tooling 14 provides the most pragmatic approach to test failure analysis. Thus, using TFAP the tooling allows the tester to prioritize initial investigative efforts without a priori knowledge of either the test or product code.

An example application is to find and analyze the first failing test in a hierarchy. For example, consider a suite of tests with a hierarchy (in ascending order) and test results of: 2-74-37-56-91. Suppose then test 37 failed: the invention determines if tests earlier in the hierarchy (i.e., 2 and 74) had failed. If 74 failed but not 2, the invention would effectively report “look at 74 before 37”.

Composition with Existing Targeted Testing

The tooling 14 may be integrated with the existing targeted testing approaches, which examine the code changes in each new product build, identifying the necessary test suites that exercise the changed functionality. The tooling 14 may be added as a simple extension. In this case, the key approach is to use TFAP to prioritize test failures.

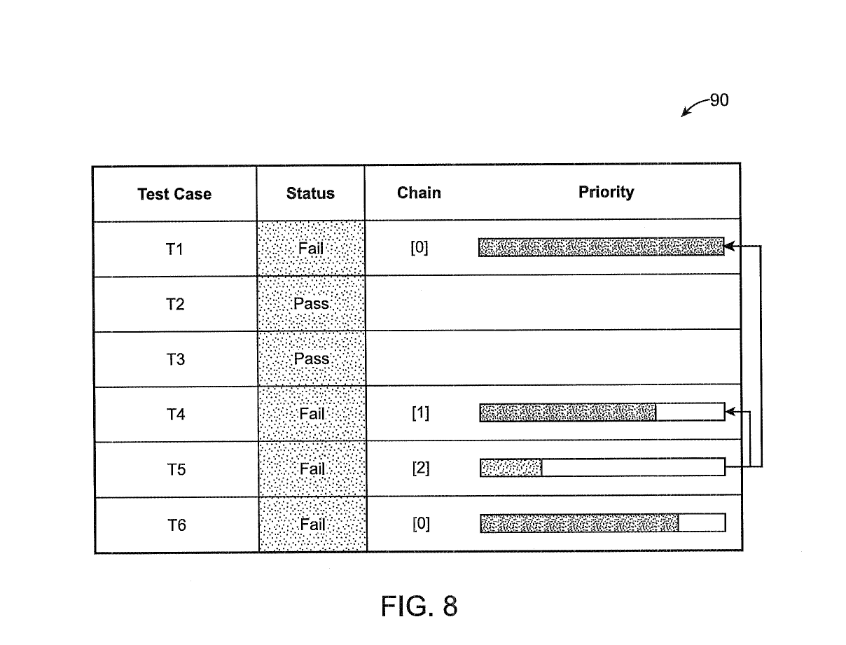

Referring to the scenario 90 in FIG. 8, as an additional example of TFAP, consider a case when T6 also fails. In this case, the tooling 14 may return the data shown in FIG. 8, illustrating an extension of the data shown in FIG. 7, with a further defect injected into the product code. In this case, T6 also fails. No further pre-requisites of T6 fail, and hence the tooling recognizes this failure as being a potentially separate defect to that observed earlier. However, a lower priority is assigned to T6 over T1 as T1 is a simpler test case, and hence easier to debug/reproduce, and fixing T1 potentially fixes two further test cases, T4 and T5. Note that such a scenario exists if there are defects in the createObjA ( ) and B. interact (C) methods.

The invention further provides a method and system for generating test case hierarchies for software code testing in an automated test execution environment. Referring back to FIG. 1, test cases 12, including test code and code coverage data, are imported into a tooling environment 14. The required information includes a test name and code coverage data (e.g., the classes and methods exercised by the test code, which can be obtained from standard code coverage tools). Importing test cases and code coverage data into a tooling environment needs to be performed once, although new tests can be added as deltas to the existing data stored in the tool. The tool 14 does not “contain” the tests themselves; rather it simply contains a repository of test names and the functional coverage they exercise.

### Hierarchy Generation

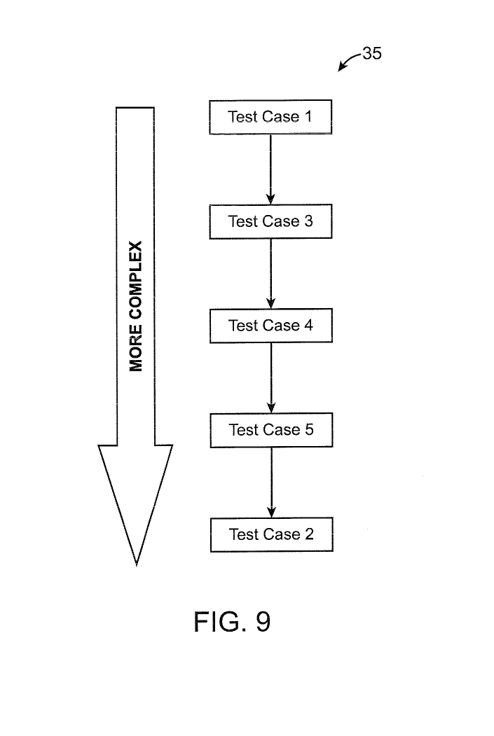

In another example, consider a hierarchy 35 shown in FIG. 9 of five tests T1-T5, demonstrating a hierarchy of functional dependence. One implementation involves determining the hierarchy; determining complexity of a given test case in a regression bucket based on code coverage data comprising methods exercised in a test case and number of lines of code in those methods; defining absolute positions in the hierarchy by the relative complexity of each test case; and extracting a test hierarchy based on code coverage data for test cases executing a common area of software code and said complexity measurements, for each of multiple tests in the regression bucket.

One example involves a “Test Case 1” (FIG. 9) that exercises one Java method. Any other test in the regression bucket that also exercises this method is deemed to be in the same hierarchy as Test Case 1. In the example shown in FIG. 9, this corresponds to Test Case 2, Test Case 3, Test Case 4 and Test Case 5. In one example, the absolute position in the hierarchy is defined by the relative complexity of each test case, an example of which is the number of lines of code (LoC) exercised. Note that complexity measurements other than LoC can be defined (e.g., length of time taken to execute, etc.).

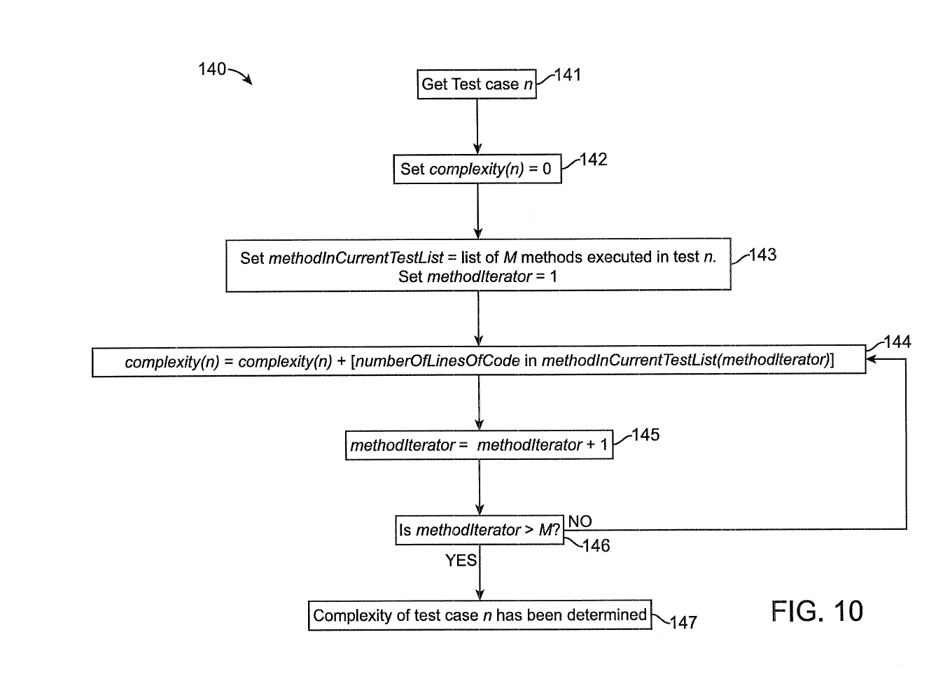

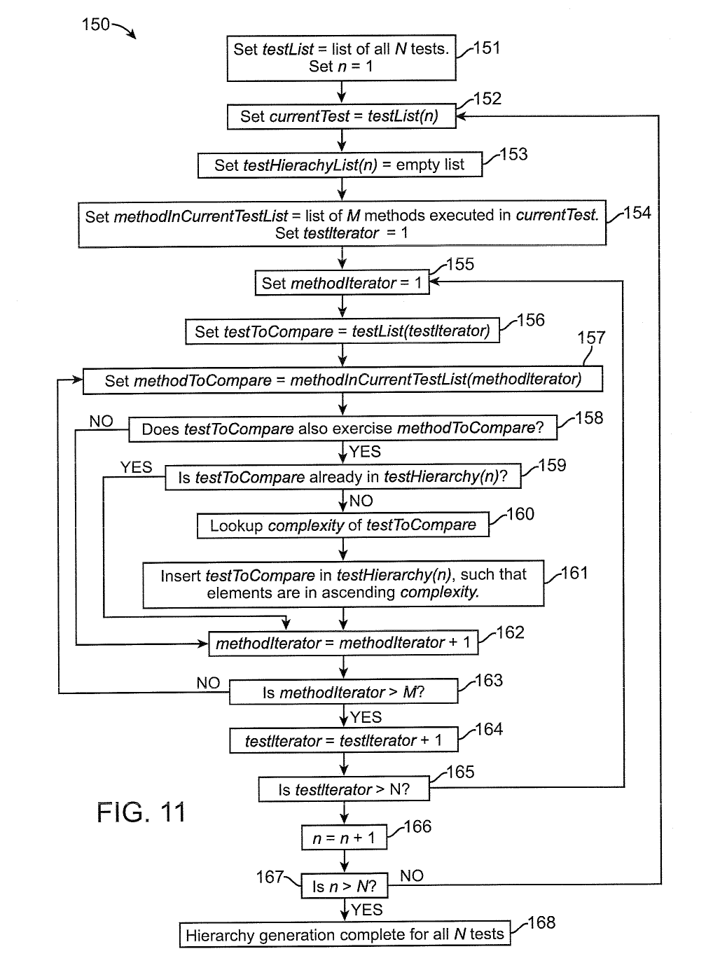

In the example above, Test Case 1 exercises the fewest LoC, and Test Case 2 the most. FIGS. 10-11 show flowcharts of blocks of processes for determining test case hierarchy, according to the invention. In one example, the hierarchy determination steps are implemented by the tooling 14 (FIG. 1).

FIG. 10 shows a process 140 for determining the complexity of a given test case in a regression bucket, according to an embodiment of the invention. As alluded above, code coverage data are used to extract the metrics methodInCurrentTestList (i.e., the methods exercised in a test case) and numberOfLinesOfCode (i.e., the number of lines of code in those methods). The process 140 includes the following functional blocks:

Block 141: Get Test case n.
Block 142: Set complexity(n) = 0.
Block 143: Set methodInCurrentTestList = list of M methods executed
in test n; set methodIterator = 1.
Block 144: complexity(n) = complexity (n) + [NumberOfLinesofCode in
methodInCurrentTestList(methodIteraor)].
Block 145: methodIterator = methodIterator + 1.
Block 146: If methodIterator > M, go to block 147, else go back to
block 144.
Block 147: Complexity of test case n has been determined.

FIG. 11 shows a process 150 for determining test hierarchies, according to an embodiment of the invention. The complexity measurements of each test case from process 40 above are used to calculate test hierarchies for each of the N test cases in the regression bucket. In this example, the full cycle is shown, iterating over each of the N test cases. Code coverage metrics are again utilized to understand whether two test cases exercise the same method (e.g., does testToCompare also exercise methodToCompare?). Again, these data are readily obtainable using current code coverage tools. The process 150 includes the following blocks:

Block 151: Set testList = List of all N tests; Set n = 1.
Block 152: Set currentTest = testList(n).
Block 153: Set testHierarchy List(n) = empty list.
Block 154: Set methodInCurrentTestList = list of M methods executed in current tests;
Set testIterator = 1.
Block 155: Set methodIterator = 1.
Block 156: Set testToCompare = testList (testIterator).
Block 157: Set methodToCompare = methodInCurrentTestList (methodIterator).
Block 158: Does testToCompare also exercise methodToCompare? If yes, go to
block 159, else go to block 162.
Block 159: Is testToCompare already in testHierarchy(n)? If yes, go to block 162,
else go to block 160.
Block 160: Look up complexity of testToCompare as computed in process 140.
Block 161: Insert testToCompare in testHierarchy(n), such that elements are in ascending
complexity.
Block 162: methodIterator = methodIterator + 1.
Block 163: Is methodIterator > M? If not, go back to block 157, else go to block
164.
Block 164: testIterator = testIterator + 1.
Block 165: Is testIterator > N? If not, go back to block 155, else go to block 166.
Block 166: n = n + 1.
Block 167: Is n > N? If not, go back to block 152, else go to block 168.
Block 168: Hierarchy generation complete for all N tests.

As is known to those skilled in the art, the aforementioned example embodiments described above, according to the present invention, can be implemented in many ways, such as program instructions for execution by a processor, as software modules, as computer program product on computer readable media, as logic circuits, as silicon wafers, as integrated circuits, as application specific integrated circuits, as firmware, etc. Though the present invention has been described with reference to certain versions thereof; however, other versions are possible. Therefore, the spirit and scope of the appended claims should not be limited to the description of the preferred versions contained herein.

Those skilled in the art will appreciate that various adaptations and modifications of the just described preferred embodiments can be configured without departing from the scope and spirit of the invention. Therefore, it is to be understood that, within the scope of the appended claims, the invention may be practiced other than as specifically described herein.

What is claimed Is:

1. A method of software code testing for an automated test execution environment, comprising:
importing test case information into a tooling environment based on code coverage and targeted testing, the test information including test name and code coverage data including classes and methods exercised by the code;
generating a test hierarchy by analyzing the individual test case information;
selecting tests including one or more of: all tests for a full regression run, a subset of tests for basic quality assurance or testing a particular area of functionality, and tests that exercise a recently changed class;
executing selected tests to generate a pass/fail result for each test and correlating the test results; and
performing test failure analysis prioritization to prioritize any failures.
